(19) United States
(12) Patent Application Publication
(10) Pub. No.: US 2009/0062138 A1
(43) Pub. Date: Mar. 5, 2009

(54) Array-based method for performing SNP analysis

(76) Inventors: Bo U. Curry, Redwood City, CA (US); Nicholas M. Sampas, San Jose, CA (US); Robert A. Ach, San Francisco, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/897,613

(22) Filed: Aug. 31, 2007

(51) Int. Cl. C40B 30/04; C40B 40/06

(52) U.S. Cl. 506/9; 506/16

(57) ABSTRACT

An array-based method for performing SNP analysis is provided. In certain embodiments, the method may comprise: a) contacting a labeled genomic sample with an array comprising a first SNP-detecting oligonucleotide and a second SNP-detecting oligonucleotide that differ from each other by a single nucleotide, under hybridization conditions that provide binding equilibrium; and b) evaluating a SNP of said labeled genomic sample by comparing: i. binding of the labeled genomic sample to the first SNP-detecting oligonucleotide and ii. binding of the labeled genomic sample to said second SNP-detecting oligonucleotide.

### BACKGROUND

During the past two decades, remarkable developments in molecular biology and genetics have produced a revolutionary growth in understanding of the implication of genes in human disease. Genes have been shown to be directly causative of certain disease states. For example, it has long been known that sickle cell anemia is caused by a single mutation in the human beta globin gene. In many other cases, genes play a role together with environmental factors and/or other genes to either cause disease or increase susceptibility to disease. Prominent examples of such conditions include the role of DNA sequence variation in ApoE in Alzheimer's disease, CKR5 in susceptibility to infection by HIV, Factor V in risk of deep venous thrombosis, MTHFR in cardiovascular disease and neural tube defects, p53 in HPV infection, various cytochrome p450s in drug metabolism, and HLA in autoimmune disease.

The genetic variations that lead to gene involvement in human disease are relatively small. Approximately 1% of the DNA bases which comprise the human genome contain polymorphisms that vary at least 1% of the time in the human population. The genomes of all organisms, including humans, undergo spontaneous mutation in the course of their continuing evolution. The majority of such mutations create polymorphisms, thus the mutated sequence and the initial sequence co-exist in the species population. However, the majority of DNA base differences are functionally inconsequential in that they affect neither the amino acid sequence of encoded proteins nor the expression levels of the encoded proteins. Some polymorphisms that lie within genes or their promoters do have a phenotypic effect and it is this small proportion of the genome's variation that accounts for the genetic component of all difference between individuals, e.g., physical appearance, disease susceptibility, disease resistance, and responsiveness to drug treatments.

One of the major forms of sequence variation in the human genome consists of single nucleotide polymorphisms (“SNPs”). Other forms of variation include copy number variations (CNVs) as well as short tandem repeats (including microsatellites), long tandem repeats (minisatellite), and other insertions and deletions. A SNP is a position (the “SNP site”, “SNP position” or “SNP nucleotide position”) at which at least two alternative bases occur, each of which at an appreciable frequency (i.e., >1%) in the human population. A SNP is said to be “allelic” in that due to the existence of the polymorphism, some members of a species may have the unmutated sequence (i.e., the original “allele”) whereas other members may have a mutated sequence (i.e., the variant or mutant allele). In the simplest case, only one mutated sequence may exist, and the polymorphism is said to be diallelic. The occurrence of alternative mutations can give rise to triallelic polymorphisms, etc. SNPs are widespread throughout the genome and SNPs that alter the function of a gene may be direct contributors to phenotypic variation. Due to their prevalence and widespread nature, SNPs are important diagnostic tools.

This disclosure relates to the detection of SNPs.

### SUMMARY

An array-based method for performing SNP analysis is provided. In certain embodiments, the method may comprise: a) contacting a labeled genomic sample with an array comprising a first SNP-detecting oligonucleotide and a second SNP-detecting oligonucleotide that differs from the first SNP-detecting oligonucleotide by a single nucleotide, under hybridization conditions that provide binding equilibrium; and b) evaluating a SNP of the labeled genomic sample by comparing: i. binding of the labeled genomic sample to the first SNP-detecting oligonucleotide and ii. binding of the labeled genomic sample to the second SNP-detecting oligonucleotide.

### BRIEF DESCRIPTION OF THE FIGURES

FIG. 1 contains three panels, A, B, and C that schematically illustrated certain elements used in some of the methods described herein.

FIG. 2 shows the nucleotide sequences of a polymorphic target, and the sequences of eight SNP-detecting oligonucleotides for detecting those targets. From top to bottom: SEQ ID NOS: 1-10.

FIG. 3 is a graph showing predicted signals for different haplotypes, based on a thermodynamic model

FIG. 4 is a graph showing observed log ratios of mismatch and deletion 60-mer probes.

FIG. 5 schematically illustrates an exemplary SNP-detecting oligonucleotide containing five destabilization elements.

FIG. 6 shows a graph illustrating results on an assay in which probes containing an increasing number of destabilizing elements are tested for binding to labeled genomic DNA.

FIG. 7 schematically illustrates an array containing multiple different sets of SNP-detecting oligonucleotides, where the sets of SNP-detecting oligonucleotides differ from one other by the number of destabilizing elements present in each of said SNP-detecting oligonucleotides.

### DEFINITIONS

The term “nucleic acid” and “polynucleotide” are used interchangeably herein to describe a polymer of any length, e.g., greater than about 10 bases, greater than about 100 bases, greater than about 500 bases, greater than 1000 bases, usually up to about 10,000 or more bases composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions. Naturally-occurring nucleotides include guanine, cytosine, adenine and thymine (G, C, A and T, respectively).

The terms “ribonucleic acid” and “RNA” as used herein mean a polymer composed of ribonucleotides.

The terms “deoxyribonucleic acid” and “DNA” as used herein mean a polymer composed of deoxyribonucleotides.

The term “oligonucleotide” as used herein denotes a single stranded multimer of nucleotide of from about 10 to 200 nucleotides. Oligonucleotides are usually synthetic and, in many embodiments, are under 80 nucleotides in length. Oligonucleotides may contain ribonucleotide monomers (i.e., may be oligoribonucleotides) or deoxyribonucleotide monomers. Oligonucleotides may be 10 to 20, 11 to 30, 31 to 40, 41 to 50, 51-60, 61 to 70, 71 to 80, 80 to 100, 100 to 150 or 150 to 200 nucleotides in length, for example.

The term “oligomer” is used herein to indicate a chemical entity that contains a plurality of monomers. As used herein, the terms “oligomer” and “polymer” are used interchangeably, as it is generally, although not necessarily, smaller “polymers” that are prepared using the functionalized substrates of the invention, particularly in conjunction with combinatorial chemistry techniques. Examples of oligomers and polymers include polydeoxyribonucleotides (DNA), polyribonucleotides (RNA), other nucleic acids that are C-glycosides of a purine or pyrimidine base, polypeptides (proteins), polysaccharides (starches, or polysugars), and other chemical entities that contain repeating units of like chemical structure.

The term “unstructured nucleic acid” or “UNA” for short, is a nucleic acid that contains one or more UNA nucleotides that bind to naturally-occurring nucleotide with higher stability than it binds to other UNA nucleotides. In certain cases, the binding between the nucleotides of a base pair containing a UNA nucleotide and a corresponding naturally occurring nucleotide may be stronger than the binding between the nucleotides of a base pair containing only naturally occurring nucleotides. For example, an unstructured nucleic acid may contain an A′ residue and a T′ residue, where those residues correspond to non-naturally occurring forms, i.e., are analogs, of A and T. The A′ and T′ residues base pair with each other with reduced stability, as compared to their ability to base pair with naturally occurring T and A residues, respectively. UNA primers bind with a higher affinity to a complementary sequence containing naturally-occurring nucleic acid than to a complementary sequence containing unstructured nucleic acid.

An “unstructured nucleic acid oligonucleotide” or “UNA oligonucleotide” for short, as will be described in much greater detail below, is a oligonucleotide that contains unstructured nucleic acid, as defined above. In other words, UNA oligonucleotides contain nucleic acid that contains one or more UNA nucleotides that bind to naturally-occurring nucleotides with higher stability than it binds other UNA nucleotides.

A primer that is made of “naturally occurring” nucleotides is a primer that is made up of naturally-occurring adenine (A), thymine (T), guanine (G), and cytosine (C) residues.

The term “sample” as used herein relates to a material or mixture of materials, typically, although not necessarily, in fluid form, containing one or more components of interest.

The terms “nucleoside” and “nucleotide” are intended to include those moieties that contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

The phrase “surface-bound nucleic acid”, e.g., a surface-bound oligonucleotide, refers to a nucleic acid that is immobilized on a surface of a solid substrate, where the substrate can have a variety of configurations, e.g., a sheet, bead, or other structure. In certain embodiments, the nucleic acid probes employed herein are present on a surface of the same planar support, e.g., in the form of an array.

An “array,” includes any two-dimensional or substantially two-dimensional (as well as a three-dimensional) arrangement of spatially addressable regions bearing nucleic acids, particularly oligonucleotides or synthetic mimetics thereof, and the like. Where the arrays are arrays of nucleic acids, the nucleic acids may be adsorbed, physisorbed, chemisorbed, or covalently attached to the arrays at any point or points along the nucleic acid chain.

Any given substrate may carry one, two, four or more arrays disposed on a surface of the substrate. Depending upon the use, any or all of the arrays may be the same or different from one another and each may contain multiple spots or features. An array may contain one or more, including more than two, more than ten, more than one hundred, more than one thousand, more ten thousand features, or even more than one hundred thousand features, in an area of less than 20 cm² or even less than 10 cm², e.g., less than about 5 cm², including less than about 1 cm², less than about 1 mm², e.g., 100 μm², or even smaller. For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, 20%, 50%, 95%, 99% or 100% of the total number of features). Inter-feature areas will typically (but not essentially) be present which do not carry any nucleic acids (or other biopolymer or chemical moiety of a type of which the features are composed). Such inter-feature areas typically will be present where the arrays are formed by processes involving drop deposition of reagents but may not be present when, for example, photolithographic array fabrication processes are used. It will be appreciated though, that the inter-feature areas, when present, could be of various sizes and configurations.

Each array may cover an area of less than 200 cm², or even less than 50 cm², 5 cm², 1 cm², 0.5 cm², or 0.1 cm². In certain embodiments, the substrate carrying the one or more arrays will be shaped generally as a rectangular solid (although other shapes are possible), having a length of more than 4 mm and less than 150 mm, usually more than 4 mm and less than 80 mm, more usually less than 20 mm; a width of more than 4 mm and less than 150 mm, usually less than 80 mm and more usually less than 20 mm; and a thickness of more than 0.01 mm and less than 5.0 mm, usually more than 0.1 mm and less than 2 mm and more usually more than 0.2 mm and less than 1.5 mm, such as more than about 0.8 mm and less than about 1.2 mm.

Arrays can be fabricated using drop deposition from pulse-jets of either precursor units (such as nucleotide or amino acid monomers) in the case of in situ fabrication, or the previously obtained nucleic acid. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. As already mentioned, these references are incorporated herein by reference. Other drop deposition methods can be used for fabrication, as previously described herein. Also, instead of drop deposition methods, photolithographic array fabrication methods may be used. Inter-feature areas need not be present particularly when the arrays are made by photolithographic methods as described in those patents.

An array is “addressable” when it has multiple regions of different moieties (e.g., different oligonucleotide sequences) such that a region (i.e., a “feature” or “spot” of the array) at a particular predetermined location (i.e., an “address”) on the array contains a particular sequence. Array features are typically, but need not be, separated by intervening spaces.

The term “mixture”, as used herein, refers to a combination of elements, that are interspersed and not in any particular order. A mixture is heterogeneous and not spatially separable into its different constituents. Examples of mixtures of elements include a number of different elements that are dissolved in the same aqueous solution, or a number of different elements attached to a solid support at random or in no particular order in which the different elements are not spatially distinct. In other words, a mixture is not addressable. To be specific, an array of surface-bound oligonucleotides, as described below, is not a mixture of surface-bound oligonucleotides because the species of surface-bound oligonucleotides are spatially distinct and the array is addressable.

“Isolated” or “purified” generally refers to isolation of a substance (compound, polynucleotide, protein, polypeptide, polypeptide composition) such that the substance comprises a significant percent (e.g., greater than 1%, greater than 2%, greater than 5%, greater than 10%, greater than 20%, greater than 50%, or more, usually up to about 90%-100%) of the sample in which it resides. In certain embodiments, a substantially purified component comprises at least 50%, 80%-85%, or 90-95% of the sample. Techniques for purifying polynucleotides and polypeptides of interest are well-known in the art and include, for example, ion-exchange chromatography, affinity chromatography and sedimentation according to density. Generally, a substance is purified when it exists in a sample in an amount, relative to other components of the sample, that is not found naturally.

The terms “determining”, “measuring”, “evaluating”, “assessing” and “assaying” are used interchangeably herein to refer to any form of measurement, and include determining if an element is present or not. These terms include both quantitative and/or qualitative determinations. Assessing may be relative or absolute. “Assessing the presence of” includes determining the amount of something present, as well as determining whether it is present or absent.

The term “using” has its conventional meaning, and, as such, means employing, e.g., putting into service, a method or composition to attain an end. For example, if a program is used to create a file, a program is executed to make a file, the file usually being the output of the program. In another example, if a computer file is used, it is usually accessed, read, and the information stored in the file employed to attain an end. Similarly if a unique identifier, e.g., a barcode is used, the unique identifier is usually read to identify, for example, an object or file associated with the unique identifier.

The term “stringent assay conditions” as used herein refers to conditions that are compatible to produce binding pairs of nucleic acids, e.g., probes and targets, of sufficient complementarity to provide for the desired level of specificity in the assay while being incompatible to the formation of binding pairs between binding members of insufficient complementarity to provide for the desired specificity. The term stringent assay conditions refers to the combination of hybridization and wash conditions.

A “stringent hybridization” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions determines whether a nucleic acid is specifically hybridized to a probe. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C. In instances wherein the nucleic acid molecules are deoxyoligonucleotides (“oligos”), stringent conditions can include washing in 6×SSC/0.05% sodium pyrophosphate at 37° C. (for 14-base oligos), 48° C. (for 17-base oligos), 55° C. (for 20-base oligos), and 60° C. (for 23-base oligos). See Sambrook, Ausubel, or Tijssen (cited below) for detailed descriptions of equivalent hybridization and wash conditions and for reagents and buffers, e.g., SSC buffers and equivalent reagents and conditions.

A specific example of stringent assay conditions is rotating hybridization at 65° C. in a salt based hybridization buffer with a total monovalent cation concentration of 1.5M (e.g., as described in U.S. patent application Ser. No. 09/655,482 filed on Sep. 5, 2000, the disclosure of which is herein incorporated by reference) followed by washes of 0.5×SSC and 0.1×SSC at room temperature.

Stringent hybridization conditions may also include a “prehybridization” of aqueous phase nucleic acids with complexity-reducing nucleic acids to suppress repetitive sequences and reduce the complexity of the sample prior to hybridization. For example, certain stringent hybridization conditions include, prior to any hybridization to surface-bound polynucleotides, hybridization with Cot-1 DNA, or the like.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions are known in the art and may also be employed, as appropriate.

As used herein, the term “genomic sample” refers to refers to a sample that contains genomic DNA from a cell, or an amplification product thereof. A genomic sample may contain genomic DNA or an amplification product thereof that is fragmented by an enzyme or by sonication, for example. The genomic sample may or may not be enriched for a particular SNP.

As used herein, the term “labeled genomic sample” refers to a genomic sample that is labeled. A genomic sample may be labeled by any of a number of methods, including, but not limited to, random priming, end labeling, and by filling in restriction enzyme overhangs.

As used herein, the term “single nucleotide polymorphism”, or “SNP” for short, refers to single nucleotide position in a genomic sequence for which two or more alternative alleles are present at appreciable frequency (e.g., at least 1%) in a population.

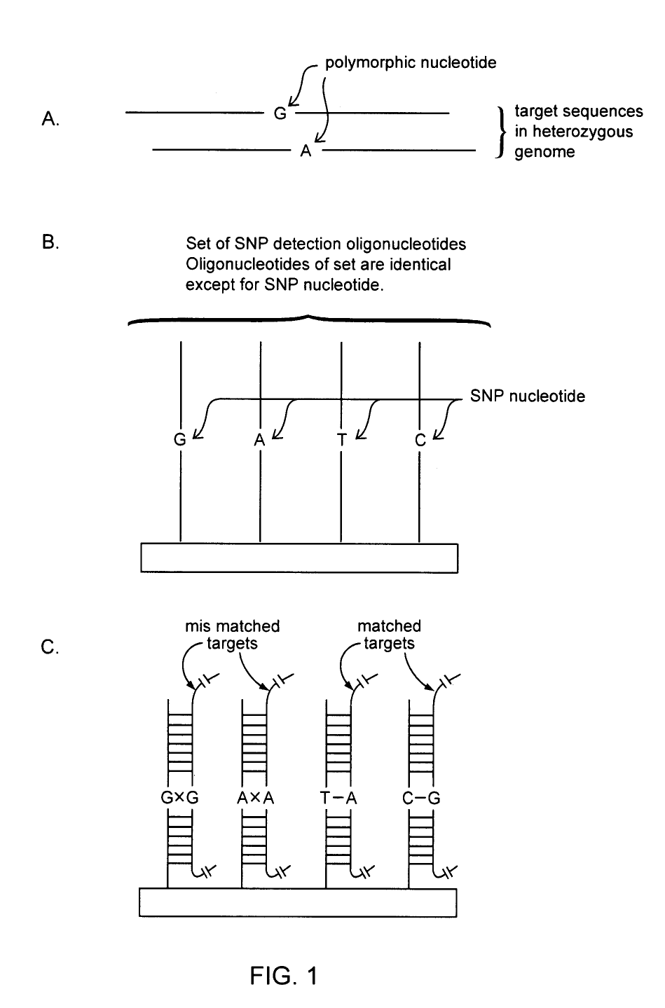

As used herein, the term “set of SNP-detecting oligonucleotides” refers to two, three or four oligonucleotides that have a sequence that hybridizes with a SNP-containing region of a genome. Except for a mismatch position that corresponds to the SNP, the oligonucleotides have an otherwise identical nucleotide sequence. The SNP nucleotide of a SNP-detecting oligonucleotide is generally positioned at the middle of the oligonucleotide. A SNP-containing region of a genome is schematically illustrated in FIG. 1, panel A, and set of four SNP-detecting oligonucleotides containing a SNP nucleotide is schematically illustrated in FIG. 1, panel B.

As shown in FIG. 1, panel C, SNP-detecting oligonucleotides may hybridize to matched targets or mis-matched targets, where a “matched target” is a SNP-containing region that contains a SNP that is complementary to the SNP nucleotide of the SNP-detecting oligonucleotide, and a mis-matched target is a SNP-containing region that contains a SNP that is not complementary to the SNP nucleotide of the SNP-detecting oligonucleotide

If a set of SNP-detecting oligonucleotides “corresponds to” or is “for” a certain SNP, the set of SNP-detecting oligonucleotides base pairs with, i.e., specifically hybridizes to, that a genomic region that contains that SNP. As will be discussed in greater detail below, a set of SNP-detecting oligonucleotide for a particular SNP and the genomic regions that contains that SNP, or complement thereof, usually contain at least one region of contiguous nucleotides that is identical in sequence that allows the oligonucleotides to hybridize to the region.

As used herein, the term “binding equilibrium” with respect to hybridization conditions refers to a state in which: a) the rate of binding between two nucleic acids to form a nucleic acid duplex; and, b) the rate of separation of the two nucleic acids of the duplex, are equal.

As used herein, the term “nucleic acid duplex” refers to the duplex formed by hybridization of two nucleic acids.

As used herein, the term “Tₘ” refers to the melting temperature of a nucleic acid duplex under the hybridization conditions used.

As used herein, the term “haplotype” refers to the identity of the nucleotide(s) that are present at a polymorphic position in the genome of a cell. For example, if the haplotype is bivariant, e.g., “A” and “B”, then the hyplotypes are AA, BB and AB.

As used herein, the term “destabilization element” refers to an element in the nucleotide sequence of a first oligonucleotide that decreases the stability of a duplex containing: a) the first oligonucleotide and b) a matched target that specifically binds to the first oligonucleotide. Nucleotide insertions, substitutions, mismatches (i.e., mismatches) and non-naturally occurring nucleotides (e.g., UNA nucleotides) are types of destabilizing elements. Exemplary destabilizing elements are described in published U.S. patent application 2007008730.

As used herein, the term “duplex destabilizing agent” refers to a compound that, when added to a hybridization reaction between to complementary nucleic acids, destabilizes the duplex formed between the nucleic acids. Duplex destabilizing agents effectively lower the Tₘ of a nucleic acid duplex.

### DESCRIPTION OF EXEMPLARY EMBODIMENTS

An array-based method for performing SNP analysis is provided. In certain embodiments, the method may comprise: a) contacting a labeled genomic sample with an array comprising a first SNP-detecting oligonucleotide and a second SNP-detecting oligonucleotide that differ from each other by a single nucleotide, under hybridization conditions that provide binding equilibrium; and b) evaluating a SNP of said labeled genomic sample by comparing: i. binding of the labeled genomic sample to the first SNP-detecting oligonucleotide and ii. binding of the labeled genomic sample to said second SNP-detecting oligonucleotide.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### SNP-Detecting Oligonucleotides

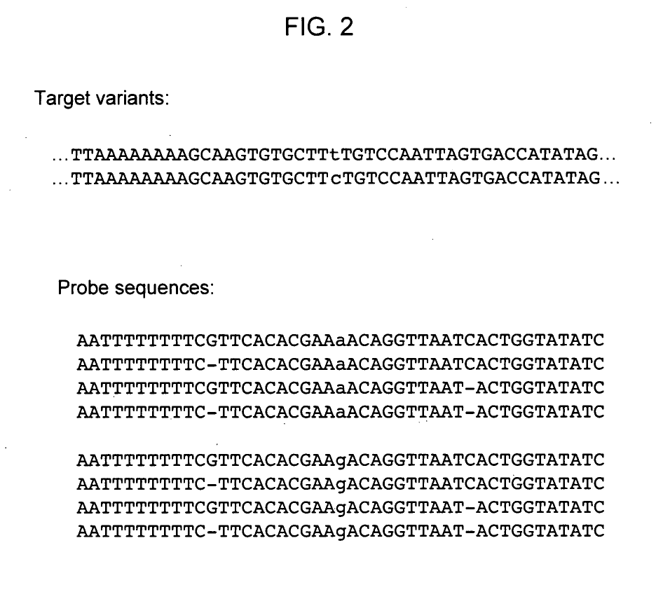

Certain embodiments of the methods described herein require the use an array comprising a set of oligonucleotides for detecting a particular SNP. A set of such oligonucleotides may include two (i.e., a “pair of SNP-detecting oligonucleotides”), three or four oligonucleotides that are identical in nucleotide sequence except for a single base, the identity of which is determined by a SNP. For example, if the SNP site has either a “G” residue or an “A” residue, then the set may contain two SNP-detecting oligonucleotides, one with a G residue and the other with an A residue at the SNP site. The number of SNP-detecting oligonucleotides may be adjusted according to the number of different residues indicated for a particular SNP, i.e., the number of different alleles. For example, if there are four residues at a particular SNP site, then there may be four SNP-detecting oligos, one with a G, one with an A, one with a T, and on one with a C, at the SNP nucleotide position. In other embodiments, a set of four SNP detecting oligonucleotides are employed regardless of the identities of the polymorphic nucleotides in the target nucleic acid. The polymorphic position may be proximal to the middle (i.e., within 5 or 10 bases either side of the middle) of a SNP-detecting oligonucleotide. FIG. 2 schematically illustrates an exemplary set of SNP-detecting oligonucleotides. The different oligonucleotides in a set are present in different features on an array (one oligonucleotide per feature). The different features may be positioned next to each other on the array, or apart from each other on the array.

Since the nucleotide sequences of hundreds of thousand of SNPs from humans, other mammals (e.g., mice), and a variety of different plants (e.g., corn, rice and soybean), are known (see, e.g., Riva et al 2004, A SNP-centric database for the investigation of the human genome BMC Bioinformatics 5:33; McCarthy et al 2000 The use of single-nucleotide polymorphism maps in pharmacogenomics Nat Biotechnology 18:505-8) and are available in public databases (e.g., NCBI's online dbSNP database, and the online database of the International HapMap Project; see also Teufel et al 2006 Current bioinformatics tools in genomic biomedical research Int. J. Mol. Med. 17:967-73) the design of SNP-detecting oligonucleotides is well within the skill of one of skill in the art. The SNP should be known prior to design of a set of SNP-detecting oligonucleotides. The SNP may be linked to a phenotype (e.g., a disease) or may be unlinked to a phenotype (e.g., may be an “anonymous” SNP.

In certain case the SNP-detecting oligonucleotides of a subject array may be “Tₘ matched” in that they are designed to have a similar melting temperature (e.g., within 1 or 2° C. of a chosen Tₘ) under the hybridization conditions used. The Tₘ of an oligonucleotide may be calculated using conventional methods, e.g., in silico or experimentally.

The length of a subject SNP-detecting oligonucleotide may be in the range of about 25-80 bases in length, e.g., in the range of 25-30, 31-40, 41-50, 51-60, 61-70 or 71-80 bases in length, or longer. In particular embodiments, subject SNP-detecting oligonucleotide may be in the range of 30-50 base in length or in the range of 51-70 bases in length.

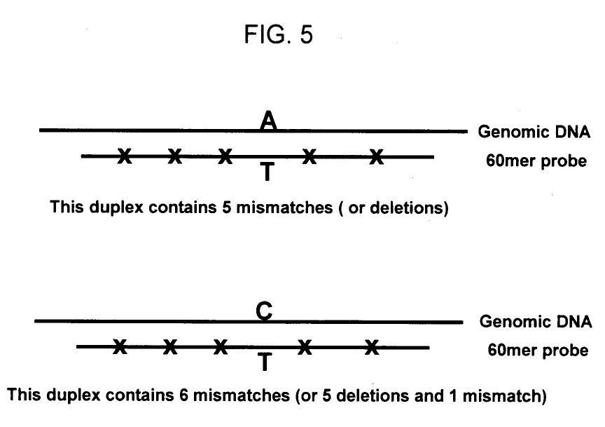

For certain longer oligonucleotides, the Tₘ of the oligonucleotide duplex formed between the oligonucleotide and the matched or mis-matched target for the oligonucleotide in the genome under examination may be reduced by one or more destabilizing elements in the oligonucleotide. Such elements include, but are not limited to, nucleotide substitutions and non-naturally occurring nucleotides that introduce a destabilizing mis-match between the oligonucleotide and the target sequence, as well as insertions and deletions of nucleotides. Exemplary destabilizing elements are described in, for example, published U.S. patent application 2007008730, by Curry. The same destabilizing element(s) should be in every oligonucleotide of a set of SNP-detecting oligonucleotides, as discussed above. Exemplary destabilizing elements are set forth in FIG. 2, and in FIG. 5. A single SNP-detecting oligonucleotide may contain 1, 2, 3, 4, 5, 6, 7, 8, 9 or 10 or more destabilizing elements, depending on the length of the oligo and the desired Tₘ. The destabilizing elements may be proximal to the SNP nucleotide of the oligonucleotide, or distributed throughout the oligonucleotide. In certain cases, the destabilizing elements are distributed evenly throughout the oligonucleotide. In particular embodiments, a SNP-detecting oligonucleotide is at least 50 nucleotides in length, and contains at least 5 destabilizing elements. In particular embodiments, a subject oligonucleotide may contain so-called unstructured nucleic acid nucleotides, which nucleotides are known and may be synthesized synthetically (Kutyavin et al., Nucl. Acids Res. (2002) 30:4952-4959).

In other embodiments, the duplex containing a SNP-detecting oligonucleotide and a matched or mis-matched target genomic sequence can be destabilized by the use of destabilizing agents that are present in the hybridization buffer. Such elements include urea, and formamide, for example.

In certain embodiments, the Tₘ of a SNP-detecting oligonucleotide is pre-selected such that, in the hybridization conditions used, the Tₘ of a duplex containing the oligonucleotide and its matched target sequence (i.e., the target sequence that contains a SNP that is complementary to the SNP nucleotide of the oligonucleotide) is higher than the hybridization temperature to be used, and the Tₘ of a duplex containing the oligonucleotide and its mismatched target sequence (i.e., the target sequence that contains a SNP nucleotide that is not complementary to the SNP nucleotide of the oligonucleotide) is lower than the hybridization temperature to be used. Illustrated by example, if the hybridization temperature to be used in 65° C., then a SNP-detecting oligonucleotide may be designed such that a duplex containing that oligonucleotide and the matched target sequence may be designed to be 66° C., and the duplex containing that oligonucleotide and the mis-matched target sequence may be designed to be 63° C.

In certain embodiments, the SNP-detecting oligonucleotides are “surface-bound SNP-detecting oligonucleotides”, where such an oligonucleotide is a SNP-detecting oligonucleotide that is bound, usually covalently but in certain embodiments non-covalently, to a surface of a solid substrate, i.e., a sheet, bead, or other structure, to form an array. In certain embodiments, surface-bound SNP-detecting oligonucleotides may be immobilized on a surface of a planar support, e.g., as part of an array.

A “SNP-detecting oligonucleotide feature” is a feature of an array, i.e., a spatially addressable area of an array, as described above, that contains a plurality of molecules of the same surface-bound SNP-detecting oligonucleotide. Accordingly, a feature contains “surface-bound” oligonucleotides that are bound, usually covalently, to an area of an array. In most embodiments a single type of oligonucleotide is present in each SNP-detecting oligonucleotide feature (i.e., all the oligonucleotides in the feature have the same sequence). However, in certain embodiments, the oligonucleotides in a feature may be a mixture of oligonucleotides with different sequence.

The subject arrays may contain a single set of SNP-detecting oligonucleotide features, e.g., a pair of features, one for each of a pair of SNP-detecting oligonucleotides, for detecting a single SNP. However, in many embodiments, the subject arrays may contain more than one such feature, and those features may correspond to (i.e., may be used to detect) a plurality of SNPs of a genome. Accordingly, the subject arrays may contain a plurality of features (i.e., 2 or more, about 5 or more, about 10 or more, about 15 or more, about 20 or more, about 30 or more, about 50 or more, about 100 or more, about 200 or more, about 500 or more, about 1000 or more, usually up to about 10,000 or about 20,000 or more features, etc.), each containing a different SNP-detecting oligonucleotide. In certain embodiments, therefore, the subject arrays contain a plurality of subject oligonucleotide features that correspond to a plurality of SNPs of a genome. In particular embodiments, therefore, the subject arrays may contain SNP-detecting oligonucleotide features for, i.e., corresponding to, all of the predicted SNPs of a particular genome. The subject arrays for may contain at least up to at least 45,000 different SNP-detecting features.

In general, arrays suitable for use in performing the subject methods contain a plurality (i.e., at least about 100, at least about 500, at least about 1000, at least about 2000, at least about 5000, at least about 10,000, at least about 20,000, usually up to about 100,000 or more) of addressable features containing oligonucleotides that are linked to a usually planar solid support. Features on a subject array usually contain polynucleotides that hybridize to, i.e., bind to, genomic sequences from a cell. Accordingly, SNP detection arrays typically involve an array containing a plurality of different sets of SNP-detecting oligonucleotides that are addressably arrayed. In certain embodiments, the subject array features may also contain other polynucleotides, such as other oligonucleotides, or other cDNAs, or inserts from phage BACs or plasmids clones. If other polynucleotide features are present on a subject array, they may be interspersed with, or in a separately-hybridizable part of the array from, the subject oligonucleotides.

In particular embodiments, SNPs of interest are represented by at least 2, about 5, or about 10 or more, e.g., up to about 20 sets of SNP-detecting oligonucleotide features. Such an array may contain duplicate oligonucleotides, or different oligonucleotides for the same SNP.

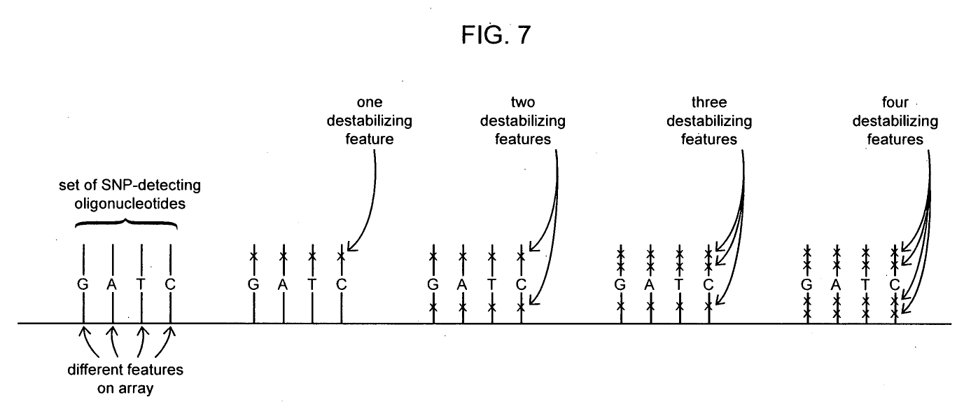

In a particular embodiment, a subject array may contain multiple different sets of SNP-detecting oligonucleotides, each for detecting the same SNP. In this embodiment, an array may comprise multiple different sets (e.g., 2, 3, 4, 5, 6, 7, 8, 9 or 10 or more sets) of SNP-detecting oligonucleotides, where the SNP-detecting oligonucleotides of each set are of identical nucleotide sequence except for the SNP nucleotide, where each of the SNP-detecting oligonucleotides specifically hybridizes to the same SNP containing region of a genome, and where the sets of SNP-detecting oligonucleotides differ from one other by the number of destabilizing elements present in each of the SNP-detecting oligonucleotides. Such an array is schematically illustrated in FIG. 7.

In general, methods for the preparation of polynucleotide arrays are well known in the art (see, e.g., Harrington et al, Curr. Opin. Microbiol. (2000) 3:285-91, and Lipshutz et al., Nat. Genet. (1999) 21:20-4) and need not be described in any great detail. The subject oligonucleotide arrays can be fabricated using any means, including drop deposition from pulse jets or from fluid-filled tips, etc, or using photolithographic means. Either polynucleotide precursor units (such as nucleotide monomers), in the case of in situ fabrication, or previously synthesized polynucleotides (i.e., UNA oligonucleotides) can be deposited. Such methods are described in detail in, for example U.S. Pat. Nos. 6,242,266, 6,232,072, 6,180,351, 6,171,797, 6,323,043, etc., the disclosures of which are herein incorporated by reference.

### SNP-Detection Methods

In general terms, the subject methods include labeling a genomic sample to make a labeled genomic sample, and then contacting the labeled genomic sample with a subject array under conditions (e.g., the combination of a hybridization buffer, temperature and time) that provide binding equilibrium. In particular embodiments, because the hybridization has reached equilibrium, the amount of binding of target nucleic acid to each SNP-detecting oligonucleotide of a set of oligonucleotides is proportional to the ratio of the binding constants of those oligonucleotides to the target nucleic acid. Thus, the haplotype of a genome with respect to a given SNP can be determined by comparing the amount of binding of a labeled genomic sample to one SNP-detecting oligonucleotide of a set, compared to another SNP-detecting oligonucleotide of the set.

In certain embodiments, the methods include labeling a genomic sample using a known method and hybridizing the labeled genomic sample with the subject oligonucleotides on the array, using known methods (e.g., Barrett et al, Comparative genomic hybridization using oligonucleotide microarrays and total genomic DNA. Proc. Natl. Acad. Sci. 2004 101:17765-70), except the methods are adapted to provide binding equilibrium. For example, in one embodiment of the instant methods, the labeled genomic sample and the array are in contact with period of time that provides for equilibrium binding. Although this time period may vary depending on the other hybridization conditions and the length and Tₘs of the oligonucleotides used, such a period may be at least 24 hours, e.g., at least 30 hours, at least 40 hours, at least 50 hours, up to about 100 or more hours).

Further, the hybridization temperature may be chosen so that it is between the Tₘ of a duplex containing an SNP-detecting oligonucleotide and its matched target sequence (i.e., the target sequence that contains a SNP that is complementary to the SNP nucleotide of the oligonucleotide), and the Tₘ of a duplex containing the oligonucleotide and its mismatched target sequence (i.e., the target sequence that contains a SNP that is not complementary to the SNP nucleotide of the oligonucleotide). Illustrated by example, if a duplex containing a SNP detecting oligonucleotide and a matched target sequence is 66° C., and the duplex containing that oligonucleotide and the mis-matched target sequence is 63° C., the temperature of the contacting step may be 65° C., for example.

As noted above, a SNP of the labeled genomic sample be evaluated by comparing: the amount of binding of the labeled genomic sample to first SNP-detection oligonucleotide and the level of binding of the labeled genomic sample to a second SNP-detection oligonucleotide, where, together the first and second oligonucleotides are members of a set of SNP-detecting oligonucleotides for detecting that SNP. In general terms, the relative levels of binding to the first and second oligonucleotides may be expressed as a ratio that indicates the haplotype of a genome under analysis. In the simplest case, i.e., where there are two alleles and a diploid genome, a ratio of more than 1.6 (e.g., 1.6 to 2.4) indicates a genome that is heterozygous for a particular SNP, and a ratio in the range of 0.8 to 1.2 indicates a haplotype that is homozygous for a particular SNP. Depending on the complexity of the genomic sample and the number of SNPs being detected at any one position (e.g., whether a given SNP position may be polymorphic for two, three or four different nucleotides) other ratios may indicate other genotypes.

In certain cases where an array containing multiple different sets of SNP-detecting oligonucleotides, where the sets of SNP-detecting oligonucleotides differ from one other by the number of destabilizing elements present in each of the SNP-detecting oligonucleotides is used, the data produced by all of the sets of SNP-detecting oligonucleotides may be processed until a meaningful ratio is identified for one of the sets.

In certain embodiments, the instant methods require quantification of binding to the oligonucleotides of a set of SNP-detecting oligonucleotides rather than an assessment of whether a particular target binds or does not bind to a oligonucleotide. Further, since certain embodiments of the instant methods rely on comparing the signals obtained from two SNP-detecting oligonucleotides hybridized with the same genomic sample, the methods may in many cases be performed in the absence of a control hybridization using, e.g., a different genomic sample (for example, a sample of known genotype) to which the results may be compared or normalized. Thus, in certain embodiments, the instant methods may be done using a “single channel”, i.e., using one type of fluorescent label, rather then using two channels, that require the use of distinguishably labeled nucleic acids. In certain cases, the method may be performed without prior target amplification or without reducing the complexity of the genomic sample.

### Utility

The above-described method may be employed to analyze SNPs. In general terms, certain embodiments of the method may comprise: a) labeling a genomic sample of unknown haplotype for a SNP, to produce a labeled sample; b) contacting the labeled sample with an array comprising a set of SNP-detecting oligonucleotides comprising a first SNP-detecting oligonucleotide and a second SNP-detecting oligonucleotide that differs from the first SNP-detecting oligonucleotide by a single nucleotide, under hybridization conditions that provide binding equilibrium; c) evaluating a SNP of the labeled sample by comparing: i. binding of the labeled genomic sample to the first oligonucleotide and ii. binding of the labeled genomic sample to the second oligonucleotide; and d) determining a SNP haplotype for the genomic sample.

In general, the subject assays involve labeling a test genomic sample to make a labeled population of nucleic acids, contacting the labeled population of nucleic acids with an array of surface bound polynucleotides under specific hybridization conditions that provide for equilibrium binding, and analyzing the data obtained from hybridization of the nucleic acids to the surface bound polynucleotides. Similar methods are generally well known in the art (see, e.g., Pinkel et al., Nat. Genet. (1998) 20:207-211; Hodgson et al., Nat. Genet. (2001) 29:459-464; Wilhelm et al., Cancer Res. (2002) 62: 957-960, Barrett et al, Comparative genomic hybridization using oligonucleotide microarrays and total genomic DNA. Proc. Natl. Acad. Sci. 2004 101:17765-70)) and, as such, need not be described herein in any great detail.

The genomic sample (containing intact, fragmented or enzymatically amplified chromosomes, or amplified fragments of the same), may be labeled using methods that are well known in the art (e.g., primer, extension, random-priming, nick translation, etc.; see, e.g., Ausubel, et al., Short Protocols in Molecular Biology, 3rd ed., Wiley & Sons 1995 and Sambrook et al., Molecular Cloning: A Laboratory Manual, Third Edition, 2001 Cold Spring Harbor, N.Y.). Suitable fluorescent labels useful in the subject methods include Cy-3 and Cy-5 (Amersham Inc., Piscataway, N.J.), Quasar 570 and Quasar 670 (Biosearch Technology, Novato Calif.), Alexafluor555 and Alexafluor647 (Molecular Probes, Eugene, Oreg.), BODIPY V-1002 and BODIPY V1005 (Molecular Probes, Eugene, Oreg.), POPO-3 and TOTO-3 (Molecular Probes, Eugene, Oreg.), fluorescein and Texas red (Dupont, Boston Mass.) and POPRO3 TOPRO3 (Molecular Probes, Eugene, Oreg.). Further suitable detectable labels may be found in Kricka et al. (Ann. Clin. Biochem. 39:114-29, 2002).

The labeling reactions produce a population of labeled nucleic acids. After nucleic acid purification and any optional pre-hybridization steps to suppress repetitive sequences (e.g., hybridization with Cot-1 DNA), the population of labeled nucleic acids are contacted to an array of surface bound polynucleotides, as discussed above, under conditions such that nucleic acid hybridization to the surface bound polynucleotides can occur to equilibrium binding, e.g., in a buffer containing 50% formamide, 5×SSC and 1% SDS at 42° C., for 30-50 hours, or in a buffer containing 5×SSC and 1% SDS at 65° C., for 30-50 hours, both with a wash of 0.2×SSC and 0.1% SDS at 65° C.

With the exception of the hybridization time, which is extended to provide equilibrium binding, standard hybridization techniques (using high stringency hybridization conditions) are used to probe a target nucleic acid array. Suitable methods are described in references describing CGH techniques (Kallioniemi et al., Science 258:818-821 (1992) and WO 93/18186). Several guides to general techniques are available, e.g., Tijssen, Hybridization with Nucleic Acid Probes, Parts I and II (Elsevier, Amsterdam 1993). For a descriptions of techniques suitable for in situ hybridizations see, Gall et al. Meth. Enzymol., 21:470-480 (1981) and Angerer et al. in Genetic Engineering: Principles and Methods Setlow and Hollaender, Eds. Vol. 7, pgs 43-65 (plenum Press, New York 1985). See also U.S. Pat. Nos. 6,335,167; 6,197,501; 5,830,645; and 5,665,549; the disclosures of which are herein incorporate by reference.

Generally, the instant methods comprise the following major steps: (1) immobilization of polynucleotides on a solid support; (2) pre-hybridization treatment to increase accessibility of support-bound polynucleotides and to reduce nonspecific binding; (3) hybridization of a mixture of labeled nucleic acids to the surface-bound nucleic acids, typically under high stringency conditions; (4) post-hybridization washes to remove nucleic acid fragments not bound to the solid support polynucleotides; and (5) detection of the hybridized labeled nucleic acids. The reagents used in each of these steps and their conditions for use vary depending on the particular application.

As indicated above, hybridization is carried out under suitable hybridization conditions, which may vary in stringency as desired. In certain embodiments, highly stringent hybridization conditions may be employed. The term “high stringent hybridization conditions” as used herein refers to conditions that are compatible to produce nucleic acid binding complexes on an array surface between complementary binding members, i.e., between the surface-bound polynucleotides and complementary labeled nucleic acids in a sample. Representative high stringency assay conditions that may be employed in these embodiments are provided above.

The above hybridization step may include agitation of the immobilized polynucleotides and the sample of labeled nucleic acids, where the agitation may be accomplished using any convenient protocol, e.g., shaking, rotating, spinning, and the like.

Following hybridization, the array-surface bound polynucleotides are typically washed to remove unbound labeled nucleic acids. Washing may be performed using any convenient washing protocol, where the washing conditions are typically stringent, as described above.

Following hybridization and washing, as described above, the hybridization of the labeled nucleic acids to the targets is then detected using standard techniques so that the surface of immobilized targets, e.g., the array, is read. Reading of the resultant hybridized array may be accomplished by illuminating the array and reading the location and intensity of resulting fluorescence at each feature of the array to detect any binding complexes on the surface of the array. For example, a scanner may be used for this purpose, which is similar to the AGILENT MICROARRAY SCANNER available from Agilent Technologies, Palo Alto, Calif. Other suitable devices and methods are described in U.S. patent application Ser. No. 09/846125 “Reading Multi-Featured Arrays” by Dorsel et al.; and U.S. Pat. No. 6,406,849, which references are incorporated herein by reference. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583 and elsewhere). In the case of indirect labeling, subsequent treatment of the array with the appropriate reagents may be employed to enable reading of the array. Some methods of detection, such as surface plasmon resonance, do not require any labeling of nucleic acids, and are suitable for some embodiments.

Results from the reading or evaluating may be raw results (such as fluorescence intensity readings for each feature in one or more color channels) or may be processed results (such as those obtained by subtracting a background measurement, or by rejecting a reading for a feature which is below a predetermined threshold, normalizing the results, and/or forming conclusions based on the pattern read from the array (such as whether or not a particular target sequence may have been present in the sample, or whether or not a pattern indicates a particular condition of an organism from which the sample came).

In certain embodiments, the subject methods include a step of transmitting data or results from at least one of the detecting and deriving steps, also referred to herein as evaluating, as described above, to a remote location. By “remote location” is meant a location other than the location at which the array is present and hybridization occurs. For example, a remote location could be another location (e.g. office, lab, etc.) in the same city, another location in a different city, another location in a different state, another location in a different country, etc. As such, when one item is indicated as being “remote” from another, what is meant is that the two items are at least in different buildings, and may be at least one mile, ten miles, or at least one hundred miles apart.

“Communicating” information means transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data. The data may be transmitted to the remote location for further evaluation and/or use. Any convenient telecommunications means may be employed for transmitting the data, e.g., facsimile, modem, internet, etc.

In certain embodiments, the level of binding of a genomic sample to a surface-bound oligonucleotide is assessed. The term “level of binding” means any assessment of binding (e.g. a qualitative or relative assessment) usually done, as is known in the art, by detecting signal (i.e., pixel brightness) from the label associated with the labeled nucleic acids. Since the level of binding of labeled nucleic acid to a surface-bound polynucleotide is proportional to the level of bound label, the level of binding of labeled nucleic acid is usually determined by assessing the amount of label associated with the surface-bound polynucleotide.

As noted above, level of binding of a subject pair of SNP-detecting oligonucleotides to a labeled genomic sample may be quantitatively evaluated, and compared to provide a ratio that indicates the genotype of a sample.

### EXAMPLE 1

The ratio of number of hybrids to two probes competing for the same target will depend at equilibrium only on the ratio of their binding constants. By comparing the signals of two probes differing only in the SNP site, the identity of the variable base in the target nucleic acid can be determined regardless of the absolute binding constants, the labeling efficiencies, or the degree of label incorporation.

To measure allele ratios, two, three or four probes complementary to the sequence surrounding a SNP in target DNA, each including a different base at the SNP site, may be used. If there are only two variants, only bases complementary to the two variants need be included in the probe.

The hybridization is allowed to proceed to equilibrium (˜50 hours for double density arrays, using Klenow-labeled target fragments). If a sample is homozygotic, the ratio of the background subtracted signal for the probe complementary to the variant present to the background subtracted signal for the mismatched probe should reflect the dG for destabilization caused by the mismatch (˜0.6 Kcal average=>2/1 K_{eq}). If the sample is heterozygotic, the signals for the two probes should be approximately equal.

The probes can be Tₘ matched, such that the Tm of the perfect match is slightly greater than the hybridization temperature, and the Tₘ of the mismatch is slightly lower. For certain hybridization conditions (e.g., in 700 mM salt, 65° C.), oligonucleotide probes that are approximately 45 nucleotides in length may be employed. In certain cases, 45-mer oligonucleotides having a single-base mismatch may not be melted at 65° C. For this reason and to allow for the variation in Tₘ among various SNP loci, other probes to each SNP site, destabilized by deleting one or two bases in the center of each half of the probe (FIG. 2), may also be included. Such probes may hybridize to the SNP targets more weakly (e.g., with about 1.2 Kcal destabilization, on average) than the perfectly matched targets, and one or another of the deletion probes will have a Tₘ near the hybridization temperature.

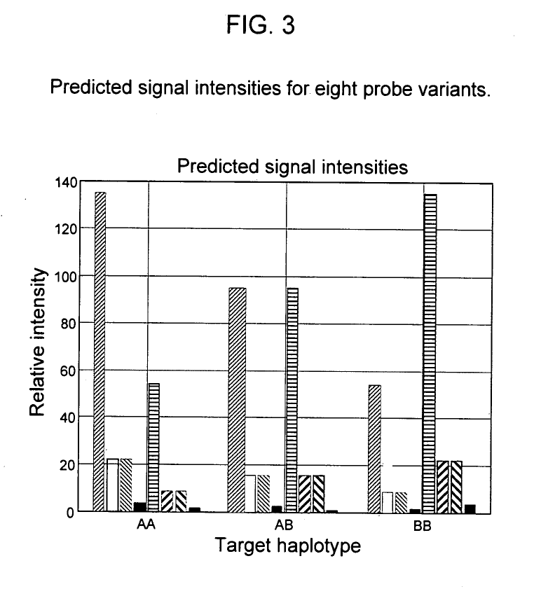

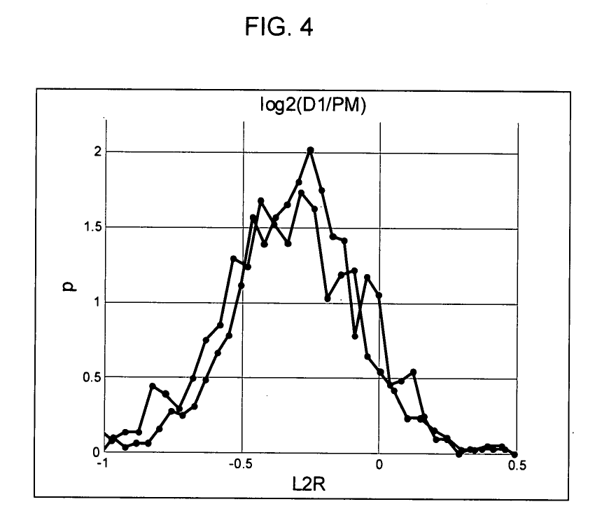

Predicted signals for different haplotypes, based on a thermodynamic model, are shown in FIG. 3. FIG. 4 shows observed log ratios of mismatch and deletion 60-mer probes to perfect matches. The distribution of log2 ratios of single-base mismatches (dashed) or deletions (solid) is shown for 900 chromosome 18 targets.

### EXAMPLE 2

In this example, 60 mer oligonucleotide probes that have multiple deletions or mismatches, when compared to the genomic region to be interrogated, are employed for SNP detection. These mismatches or deletions would be in nucleotides that are not being used to interrogate the particular SNP of interest. These mismatches/deletions destabilize the duplex between the probe and the genomic DNA enough so that the addition of one more mismatch, due to the SNP, would show a greatly reduced hybridization signal when compared to genomic DNA that matched perfectly at the interrogation site (see FIG. 5). By adding mismatches or deletions to the probe that lie outside of the SNP interrogation region, the probe/genomic DNA duplex is destabilized, making it more susceptible to an additional mismatch.

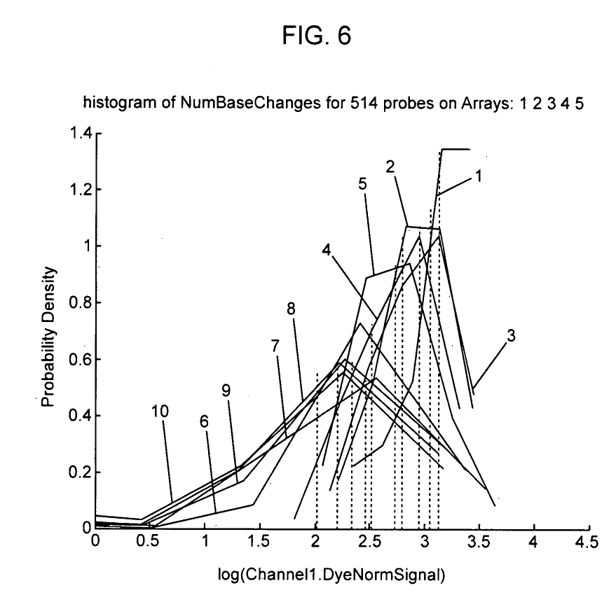

One embodiment of this method has been tested by constructing 50 mer probes with randomly spaced deletions and hybridizing those probes to labeled genomic DNA. An example of the results are shown in FIG. 6. Each curve (labeled 1-10, depending on the number of mismatches contained in the oligonucleotide) represents the distribution of hybridization signal strengths (DyeNormSigs) from probes with 0-10 deletions. As can be seen, the center of the distributions shift towards lower signals for each deletion that is added to the probe. There is a relatively large step downwards in the stability of probes with 5 vs. 6 deletions, indicating this might be a good number of deletions to test for SNP detection ability. Note that in this experiment the deletions were randomly spaced, and deletions spaced in a regular or predetermined manner may also be employed.

All publications and patent applications cited in this specification are herein incorporated by reference as if each individual publication or patent application were specifically and individually indicated to be incorporated by reference. The citation of any publication is for its disclosure prior to the filing date and should not be construed as an admission that the present invention is not entitled to antedate such publication by virtue of prior invention.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

What is claimed is:

1. A method comprising:
a) contacting a labeled genomic sample with an array comprising a first SNP-detecting oligonucleotide and a second SNP-detecting oligonucleotide that differs from the first SNP-detecting by a single nucleotide, under hybridization conditions that provide binding equilibrium; and
b) evaluating a SNP of said labeled genomic sample by comparing:
i. binding of said labeled genomic sample to said first oligonucleotide and
ii. binding of said labeled genomic sample to said second oligonucleotide.

2. The method of claim 1, wherein said hybridization conditions comprise a hybridization temperature that is between:
a) the Tₘ of a nucleic acid duplex comprising said first SNP-detecting oligonucleotide and a matched target sequence that contains a polymorphic nucleotide that is complementary to the SNP nucleotide of said first SNP-detecting oligonucleotide; and
b) the Tₘ of a nucleic acid duplex comprising said first SNP-detecting oligonucleotide and a mis-matched target sequence that contains a polymorphic nucleotide that is not complementary to the SNP nucleotide of said first SNP-detecting oligonucleotide.

3. The method of claim 1, wherein said evaluating provides a ratio indicating the level of binding to said first SNP-detecting oligonucleotide relative to the level of binding to said second SNP-detecting oligonucleotide.

4. The method of claim 1, wherein a ratio of more than 1.6 indicates a haplotype that is homozygous for a particular SNP.

5. The method of claim 1, wherein a ratio in the range of 0.8 to 1.2 indicates a haplotype that is heterozygous for a particular SNP.

6. The method of claim 1, wherein said first and second oligonucleotides comprise a destabilization feature.

7. The method of claim 6, wherein said destabilization feature is a substitution, deletion, insertion or non-naturally occurring nucleotide that reduces the Tₘ of a nucleic acid duplex comprising said first or second oligonucleotide and a nucleic acid sequence in said labeled genomic sample.

8. The method of claim 7, wherein said non-naturally occurring nucleotide is an unstructured nucleic acid (UNA) nucleotide.

9. The method of claim 1, wherein said hybridization conditions comprise a duplex destabilizing agent that decreases the Tₘs of said first and second oligonucleotides.

10. The method of claim 1, wherein said duplex destabilizing agent is urea or formamide.

11. The method of claim 1, wherein said evaluating is quantitative.

12. The method of claim 1, wherein said first and second oligonucleotides are at least 30 nucleotides in length.

13. The method of claim 1, wherein said first and second oligonucleotides are at least 50 nucleotides in length and comprise at least five destabilization features.

14. The method of claim 1, wherein said method comprises indicating the haplotype of said labeled genomic sample on the basis of said evaluating.

15. A method comprising:
a) labeling a genomic sample of unknown haplotype for a chosen SNP, to produce a labeled sample;
b) contacting said labeled sample with an array comprising a first SNP detecting oligonucleotide and a second SNP detecting oligonucleotide that differs from the first SNP detecting oligonucleotide by a single nucleotide, under hybridization conditions that provide binding equilibrium;
c) evaluating a SNP of said labeled sample by comparing:
i. binding of said labeled genomic sample to said first homozygous oligonucleotide and
ii. binding of said labeled genomic sample to said second homozygous oligonucleotide; and
d) determining a SNP haplotype for said genomic sample.

16. The method of claim 15, wherein said method does not comprise contacting said array with a control labeled genomic sample made from a genomic sample of known haplotype.

17. The method of claim 15, wherein said genomic sample is amplified or non-amplified prior to said labeling step.

18. The method of claim 15, wherein said genomic sample is not enriched for nucleic acid that contain said SNP, prior to said labeling.

19. An array comprising multiple different sets of SNP-detecting oligonucleotides,
wherein the SNP-detecting oligonucleotides of each set are of identical nucleotide sequence except for the SNP nucleotide of each oligonucleotide;
wherein each of the SNP-detecting oligonucleotides specifically hybridizes to the same SNP containing region of a genome; and
wherein the sets of SNP-detecting oligonucleotides differ from one other by the number of destabilizing elements present in each of said SNP-detecting oligonucleotides.

20. The array of claim 19, wherein said array comprises in the range of two to ten different sets of SNP-detecting oligonucleotides that differ from one other by the number of destabilizing elements present in each of said SNP-detecting oligonucleotides.


SEQUENCE LISTING (10 sequences)

SEQ ID NO: 1 - DNA, 45 bp, Artificial Sequence
  synthetic oligonucleotide
ttaaaaaaaagcaagtgtgcttttgtccaattagtgaccatatag

SEQ ID NO: 2 - DNA, 45 bp, Artificial Sequence
  synthetic oligonucleotide
ttaaaaaaaagcaagtgtgcttctgtccaattagtgaccatatag

SEQ ID NO: 3 - DNA, 45 bp, Artificial Sequence
  synthetic oligonucleotide
aattttttttcgttcacacgaaaacaggttaatcactggtatatc

SEQ ID NO: 4 - DNA, 44 bp, Artificial Sequence
  synthetic oligonucleotide
aattttttttcttcacacgaaaacaggttaatcactggtatatc

SEQ ID NO: 5 - DNA, 44 bp, Artificial Sequence
  synthetic oligonucleotide
aattttttttcgttcacacgaaaacaggttaatactggtatatc

SEQ ID NO: 6 - DNA, 43 bp, Artificial Sequence
  synthetic oligonucleotide
aattttttttcttcacacgaaaacaggttaatactggtatatc

SEQ ID NO: 7 - DNA, 45 bp, Artificial Sequence
  synthetic oligonucleotide
aattttttttcgttcacacgaagacaggttaatcactggtatatc

SEQ ID NO: 8 - DNA, 44 bp, Artificial Sequence
  synthetic oligonucleotide
aattttttttcttcacacgaagacaggttaatcactggtatatc

SEQ ID NO: 9 - DNA, 44 bp, Artificial Sequence
  synthetic oligonucleotide
aattttttttcgttcacacgaagacaggttaatactggtatatc

SEQ ID NO: 10 - DNA, 43 bp, Artificial Sequence
  synthetic oligonucleotide
aattttttttcttcacacgaagacaggttaatactggtatatc